(19) United States
(12) Patent Application Publication
(10) Pub. No.: US 2020/0326057 A1
(43) Pub. Date: Oct. 15, 2020

(54) NEON LAMP LOCKING CHANNEL

(71) Applicant: Sikai Chen, Delran, NJ (US)

(72) Inventor: Sikai Chen, Delran, NJ (US)

(21) Appl. No.: 16/452,685

(22) Filed: Jun. 26, 2019

Related U.S. Application Data
(60) Provisional application No. 62/833,884, filed on Apr. 15, 2019.

(51) Int. Cl. F21V 19/00

(52) U.S. Cl. CPC F21V 19/0095; F21Y 2103/37

(57) ABSTRACT

A locking channel has a series of inwardly extending locking tab members. The base section of a neon lamp is positioned within the locking channel and secured and locked in place by means of the locking tab members. This system can be used with locking channels which are straight, angled or of any curved configuration.

### RELATED APPLICATION

This application claims the benefit of provisional application Ser. No. 62/833,884, filed on Apr. 15, 2019.

### FIELD OF THE INVENTION

The present invention relates to a unique means of simply and effectively attaching an LED neon lamp within a support channel.

### BACKGROUND OF THE INVENTION

LED neon lamps, especially such lamps which are elongated, are routinely mounted within channel members. The channel members can take the form of any number of configurations, from being linear to being curved in a variety of shapes. The neon lamps themselves most commonly comprise base sections which fit into the channels, while the light sections of the neon lamps extend up from the base sections.

Present practice consists of affixing the base sections of the neon lamps to the channels using glue, epoxy, or equivalent attachment substances. This practice is laborious and, often times, quite messy, sometimes creating an unsightly result. Significantly, this attachment technique, in many cases, is ineffective in maintaining the neon lamp in the channel over time.

### SUMMARY OF THE INVENTION

It is thus the object of the present invention to provide a neon lamp locking channel which addresses and overcomes the limitations and disadvantages of existing neon lamp to channel attachment means.

This and other objects are accomplished by the present invention, a locking channel which utilizes a series of inwardly extending locking tab members. The base section of a neon lamp is positioned within the locking channel and secured and locked in place by means of the locking tab members. This system can be used with locking channels which are straight, angled or of any curved configuration.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective top view of a curved locking channel of the present invention, showing its inwardly extending locking tabs.

FIG. 2 is a bottom perspective view of the locking channel of the present invention.

FIG. 3 is a top view of the locking channel of the present invention.

FIG. 4 is a bottom view of the locking channel of the present invention.

FIG. 5 shows an “S” shaped neon lamp which is to be installed in an “S” shaped locking channel of the present invention, FIG. 6, resulting in the connection of the neon lamp into the locking channel, FIG. 7.

FIG. 8 illustrates a neon lamp secured within a locking channel of the present invention and connected to a power source for the neon lamp.

FIG. 9 illustrates a straight, linear locking channel of the present invention, with a neon lamp connected therein.

FIG. 10 shows an angled locking channel of the present invention.

FIG. 11 shows a neon lamp being secured within a locking channel of the present invention.

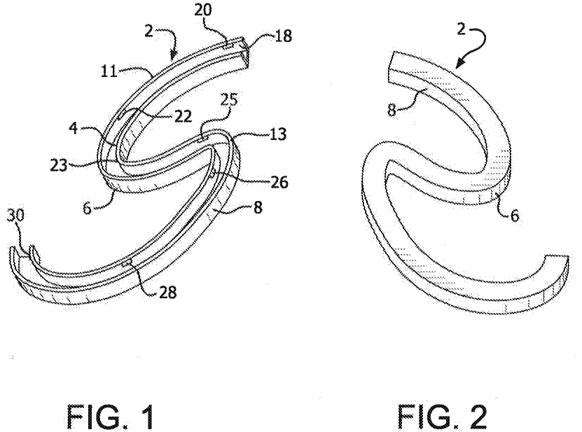

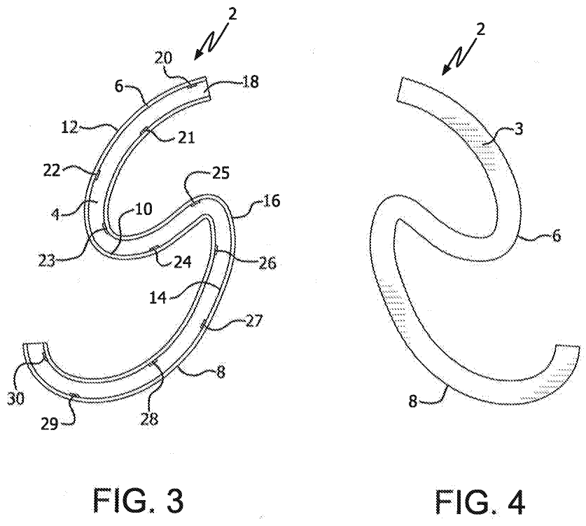

### DETAILED DESCRIPTION OF THE INVENTION

Locking channel 2 comprises bottom floor 4 with exterior surface 3 extending the length of the channel, and dual sidewalls 6 and 8 extending up from and extending the length of the bottom floor. Sidewalls 6 and 8 have interior surfaces 10 and 14, exterior surfaces 12 and 16, and top edges 11 and 13. Open passageway 18 is formed between bottom floor 4 and sidewalls 6 and 8.

A series of locking tab members 20-30 extend inwardly, in spaced apart relation to each other, from interior surfaces 10 and 14 of sidewalls 6 and 8. Locking tab members are located adjacent to top edges 11 and 13 of sidewalls 6 and 8.

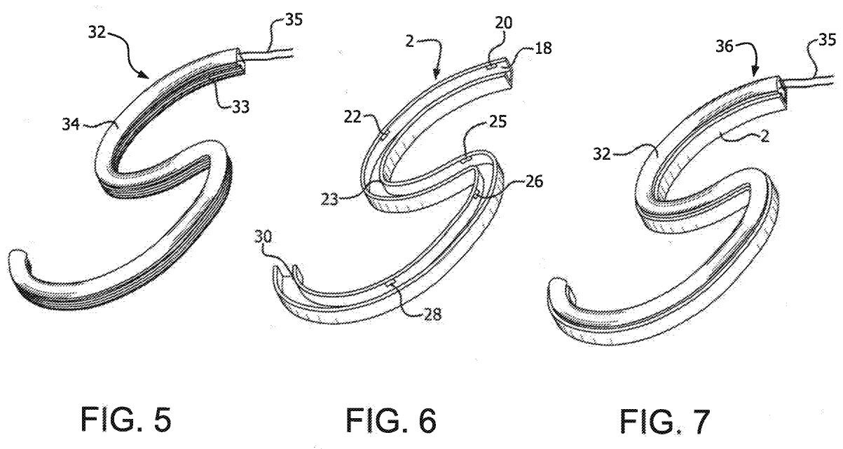

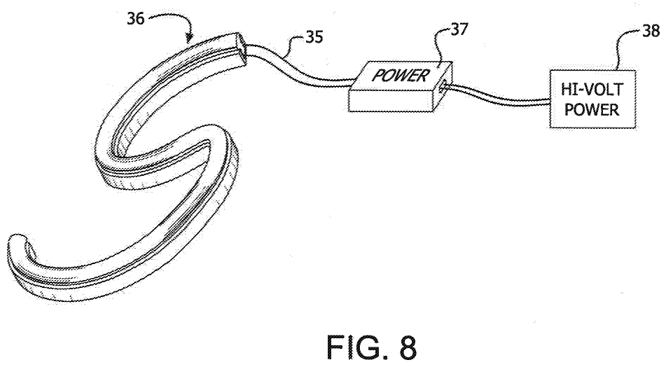

FIGS. 5-8 illustrate the manner of use of the locking channel of the present invention. FIG. 5 shows an. LED neon lamp 32 having base section 33 and lamp section 34. Electrical wire connections 35 extend from lamp section 34. Base section 33 of neon lamp 32 is configured to be placed within open passageway 18 of locking channel 2 and secured and locked within the channel by means of all the locking tabs, locking tabs 20, 22, 23, 25, 26, 28, and 30 being shown in FIG. 6. The assembled neon lamp and locking channel unit 36 is shown in FIG. 7 and FIG. 8. FIG. 8 shows the assembled neon lamp and channel unit connected to electrical power sources 37 and 38.

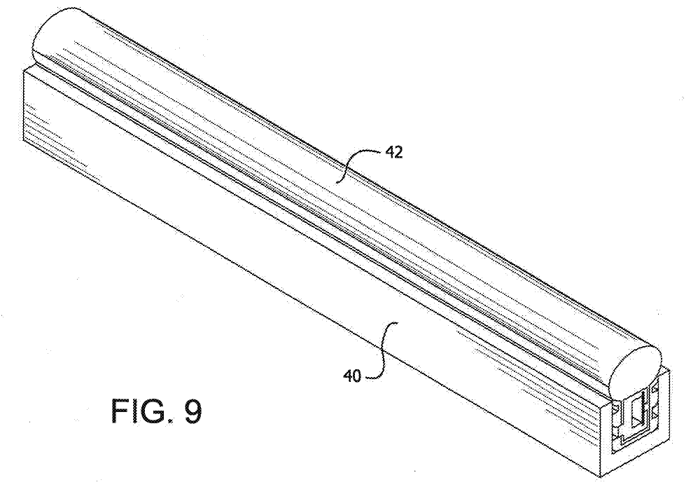

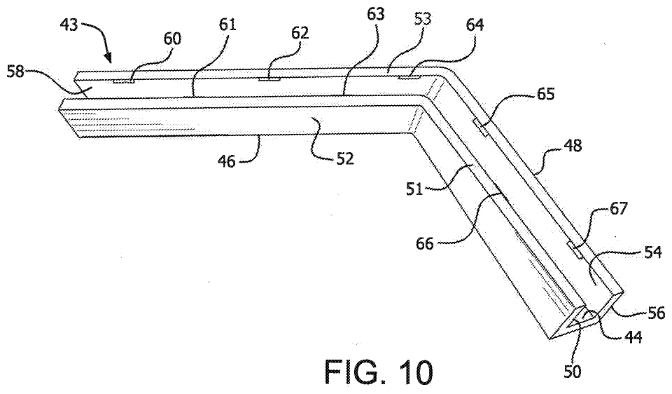

Locking channel 2 is shown having a curved design, however, it is contemplated that the locking channel of the present invention can be configured in any configuration, including straight or linear. FIGS. 9 shows locking channel 40 having straight run and connected to neon lamp 42. FIG. 10 shows angled locking channel 43, with bottom floor 44. Sidewalls 46 and 48 have interior surfaces 50 and 54, exterior surfaces 52 and 56 and top edges 51 and 53. Open passageway 58 is formed between bottom floor 44 and sidewalls 46 and 48.

A series of locking tab members 60-67 extend in spaced apart relation to each other from interior surfaces 50 and 54 of sidewalls 46 and 48. The locking tab members are located adjacent to top edges 51 and 53 of sidewalls 46 and 48.

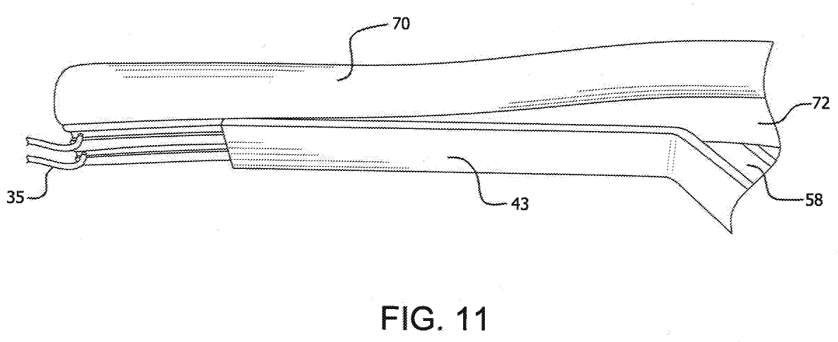

Base section 72 of neon lamp 70 is configured to be placed within open passageway 58 of locking channel 43, as seen in FIG. 11 and secured and locked within the channel by the locking tab members.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A locking channel for a neon lamp having a base section and a lamp section extending up from the base section, the locking channel comprising:
a bottom floor extending the length of the channel;
dual side walls extending the length of and up from the bottom floor, said side walls having interior and exterior surfaces;
an open passageway formed between the bottom floor and the side walls, the base section of the neon lamp being configured to be placed in the passageway; and
a series of locking tab members extending inwardly from the interior surfaces of the side walls into the passageway, wherein upon the placement of the base section of the neon lamp within the passageway, the locking tab members secure and lock the base section of the neon lamp directly to the locking channel, thereby locking the neon lamp to the locking channel with the lamp section extending above the locking channel.

2. The locking channel as in claim 1 wherein the bottom floor and the side walls comprise a straight configuration.

3. The locking channel as in claim 1 wherein the bottom floor and side walls comprise a curved configuration.

4. The locking channel as in claim 1 wherein the locking tab members are in spaced apart relation to one another.

5. The locking channel as in claim 1 wherein the side walls have a top edge and the locking tab members are located adjacent to the top edge of the side walls.

6. The locking channel as in claim 5 wherein the locking tab members are in spaced apart relation to one another.

7. A neon lamp and locking channel unit comprising:
a neon lamp having a lamp section extending up from a base section; and
a locking channel comprising a bottom floor extending the length of the channel, dual side walls extending the length of and up from the bottom floor, said side walls having interior surfaces and exterior surfaces, an open passageway formed between the bottom floor and the side walls, and a series of locking tab members extending inwardly from the interior surfaces of the side walls into the passageway, and wherein the base section of the neon lamp is located within the passageway, the locking tab members securing and locking the base section to the channel to lock the neon lamp to the locking channel with the lamp section extending above the locking channel.

8. The neon lamp and locking channel as in claim 7 wherein the bottom floor and the side walls comprise a straight configuration.

9. The neon lamp and locking channel unit as in claim 7 wherein the bottom floor and side walls comprise a curved configuration.

10. The neon lamp and locking channel unit as in claim 7 wherein the locking tab members are in spaced apart relation to one another.

11. The neon lamp and locking channel unit as in claim 7 wherein the side walls have a top edge and the locking tab members are located adjacent to the top edge of the side walls.

12. The neon lamp and locking channel unit as in claim 11 wherein the locking tab members are in spaced apart relation to one another.
